(19) United States
(12) Patent Application Publication
(10) Pub. No.: US 2015/0127504 A1
(43) Pub. Date: May 7, 2015

(54) METHOD AND SYSTEM FOR ORIGINATING A BANKING RELATIONSHIP USING DIFFERENT ELECTRONIC COMMUNICATION CHANNELS

(71) Applicant: INFOSYS LIMITED, BANGALORE (IN)

(72) Inventors: Amit Vats, Punjab (IN); Udhyakumar Namakkal Muthuswamy, Chennai (IN); Saswat Kumar Padhi, Orissa (IN)

(21) Appl. No.: 14/368,501

(22) PCT Filed: Jan. 5, 2012
(86) PCT No.: PCT/IN2012/000010

§ 371 Date: Jun. 24, 2014

(51) Int. Cl. G06Q 40/02

(52) U.S. Cl. CPC G06Q 40/02
USPC 705/35

(57) ABSTRACT

A system and method for originating a banking relationship with a bank using at least one electronic communication channel is disclosed. A request is received from a user through a first electronic communication channel wherein the user selects a financial product among a list of different financial products offered by the bank. The user is enabled to send user's information through a second electronic communication channel. The information is received either through the first electronic communication channel or the second electronic communication channel. A validation check is performed on the information and the validated information is processed to check if the user is allowed to access the selected financial product. After processing the information, a reference number for the selected financial product is provided to the user, thereby originating the banking relationship for the user.

### RELATED APPLICATION DATA

This application claims priority to International Application No. PCT/IN2012/000010, filed Jan. 5, 2012, the disclosure of which is hereby incorporated in its entirety.

### FIELD OF THE INVENTION

The present disclosure in general relates to originating a banking relationship. In particular, the invention discloses a method and system to originating a banking relationship using different electronic communication channels.

### BACKGROUND OF THE INVENTION

In today's scenario, a bank provides a number of banking services that include both financial services like keeping customer's money safe while providing them with the withdrawal option, issuance of the checkbooks, credit card, debit card etc., providing different loans, bank accounts, insurance, overdraft agreements etc. and non-financial services to a user. Banking services are provided for a particular financial product. A financial product is generally offered by a bank. Some of the examples of financial products are demat account, loan account, mortgage account, credit card account, insurance, savings bank account, current account, mutual fund account, recurring deposit account, fixed deposit account, proprietorship account, partnership account, joint account, overdraft account and transactional account. When a customer chooses any of the banking services with respect to a financial product, the customer enters into a banking relationship with the bank.

Typically, a banking relationship is initiated when a customer goes to a bank and requests for a banking service with respect to a financial product. Generally the bank requires the customer to fill in his information on templates or forms provided by the bank and submit documents for verification. After verification of the information and documents, the bank originates a banking relationship.

Alternatively, banks also provide a facility to the customer to fill in the information on the templates/forms provided on the website of the bank and submit the print out of the forms with the documents in person to any branch of the bank. This requires the customer to go to the bank in person and perform the steps to originate a banking relationship with the bank. The customer might have to go more than once to complete the formalities.

There is a general need to enable a customer to originate a banking relationship with a bank without going to the bank in person. Several aspects of the present disclosure facilitate the faster origination of a banking relationship between the bank and the customer as described in below sections.

### SUMMARY OF THE INVENTION

The present disclosure discloses a method for originating a banking relationship with a bank using at least one electronic communication channel that includes wired or wireless or combination of wired and wireless communication channels. A request is received from a user through a first electronic communication channel wherein the user selects a financial product among a list of different financial products offered by the bank. The user is enabled to send user's information through a second electronic communication channel. The information is received either through the first electronic communication channel or the second electronic communication channel. Validations check including field level or process level validation is performed on the information and the validated information is processed to check if the user is allowed to access the selected financial product. The bank is enabled to configure the processing of the user information. After processing the information, a banking relationship reference number for the selected financial product is provided to the user, thereby originating the banking relationship for the user. Further alerts are sent during the origination of banking relationship.

In one embodiment of the present disclosure, the user information can be saved and modified multiple times before processing it. Further, saving and modifying can happen across different electronics channels. The step of processing the user information may also comprise checking duplicate entries of the user information.

In yet another embodiment of the present disclosure, the user is enabled to perform one or more of: cross-sell, up-sell, down-sell based on the user information specifically evaluated for each user. The user can also be provided with different tools like calculators, simulators, modelers configured to demonstrate a plurality of benefits and features of the banking relationship.

Further in another embodiment of the present disclosure, the user is enabled to select one or more financial products by submitting the user information at most once. In case of joint account, a joint account user can independently submit the user information for the joint account.

Furthermore in one embodiment of the present disclosure, the user selects the financial product on a template that is configured based on the selected financial product. Alternatively, the template can also be customized based on geographical regulations, selection of the financial products, and preference of the user.

The present disclosure further discloses a system for originating the banking relationship using at least one electronic communication channel that includes wired or wireless or combination of wired and wireless communication channel. System contains receiving module, information retrieving module, validation module, processing module and account origination module. Receiving module is configured to receive a request from a user through a first electronic communication channel wherein the user selects a financial product among a list of different financial products offered by a bank. Information retrieving module is configured to receive user information either through the first electronic communication channel or a second electronic communication channel. Validation module is configured to perform at least one validation check that includes field level and process level validation, on the user information. Thereafter, processing module is configured to check the eligibility criteria of the user to access the selected financial product and origination module originates the banking relationship for the user by providing a banking relationship reference number. Processing module may also be configured to send alert during the process of origination of the banking relationship.

In one embodiment of the present disclosure, the processing module is further configured to enable the user to perform one or more of: cross-sell, up-sell, down-sell based on the user information specifically evaluated for each user.

In another embodiment of the present disclosure, the processing module may also be configured to enable the user to create a joint account, wherein a joint account user can independently submit the user information for the joint account. Further processing module performs duplication check.

In yet another embodiment of the present disclosure, the processing module may be configured to enable the bank to configure processing of the user information.

### BRIEF DESCRIPTION OF THE DRAWINGS

FIG. 1 is an illustrative diagram depicting the manner in which banking relationships are originated in prior approaches.

FIG. 2 is an illustrative diagram to explain the manner of originating a banking relationship with a bank using different electronic communication channels according to an aspect of the present invention.

FIG. 3 is a block diagram illustrating the details of an example system enabling a user to originate a banking relationship with a bank using different electronic communication channel in which several aspects of the present disclosure can be implemented.

FIG. 4 is an example embodiment according to an aspect of the present disclosure.

FIG. 5 is a system illustrating a generalized computer network arrangement, in one embodiment of the present technique.

### DETAILED DESCRIPTION OF THE INVENTION

Prior Approaches to Originate Banking Relationship

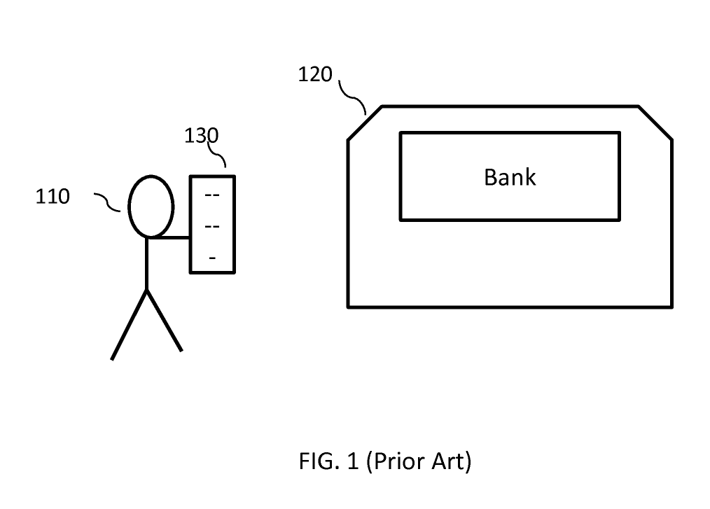

FIG. 1 depicts the manner in which banking relationships are originated in prior approaches. User 110 is a person who wants to originate a banking relationship with bank 120. In one of the prior approaches, user 110 first goes to bank 120 and request for a banking service regarding a financial product. Bank 120 requires user 110 to fill in his information on template/form 130 and to submit documents for verification. Thereafter, bank 120 verifies the information and documents provided by user 110. It checks if the user is allowed to access the requested financial product. After verification and checking, user 110 is provided with a reference number, thereby establishing a banking relationship. The reference number is a unique number which will identify user 110 with the requested banking service for the selected financial product.

In another prior approach, customer 110 selects for a banking service regarding a financial product on the website of bank 120 through internet. The websites display a template/form corresponding to the selected banking service. Customer 110 fills up the template/form and submits the print out of template/form 130 with a branch of bank 120. After verifying the information submitted on template/form 130, bank 120 provides a reference number.

It may be appreciated that origination of banking relationship in prior approaches requires the customer to go to a branch of a bank in person and the process of originating a banking relationship takes lot of days. Further, one of the challenges in origination of banking relationship is that bank does not enable user to use different electronics communication channel during the process of origination of banking relationship. For example, if a user has fill in his information in a template through computer system and later wants to modify his information using mobile application before taking the print out, he is not enable to do the modification through mobile application. For modification, he has to access the template through computer system.

Originating Banking Relationship Using Different Electronic Channel

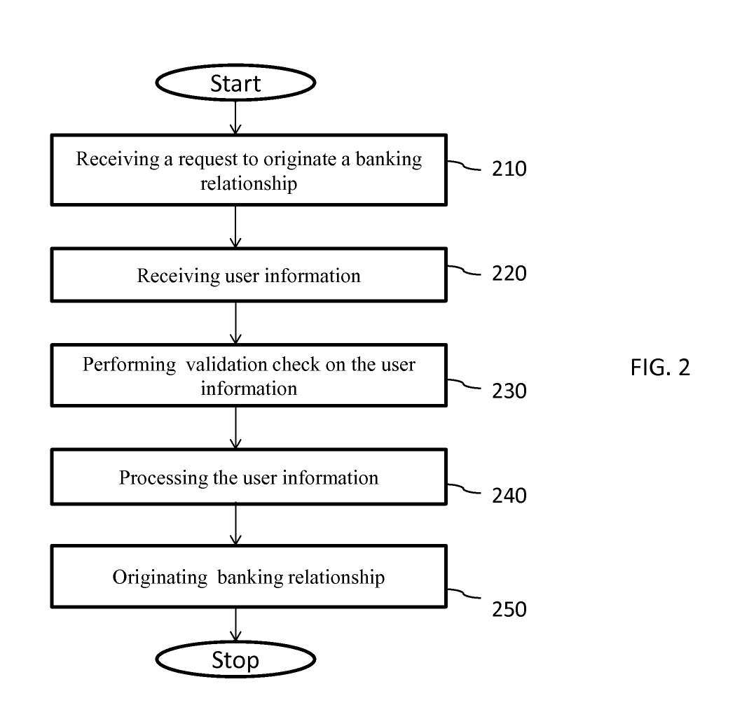

FIG. 2 illustrates the manner of originating a banking relationship with a bank using different electronic communication channels according to an aspect of the present invention. Bank 120 may provide an online user interface displaying a list of banking services regarding a financial product for user 110. Bank 120 can receive a request to originate a banking relationship when user 110 may select a banking service for a required financial product on the user interface through an electronic communication channel including wireless, wired or combination of both (step 210). The electronic communication channels may be over the internet, near field communication (“NFC”), Bluetooth, local area network (“LAN”), wide area network (“WAN”), mobile phone network, or any other communication network or combination of communication networks.

In one embodiment, user can select more than one financial product and submits his information only once. In case, the selected financial product is a joint account, every joint account holder can submit his information independently. A template/form corresponding to the selected banking service may be displayed on the user interface. User 110 may fill in the information as required in the template. In one of the embodiments, user can save the information any number of times before finally submitting the template/form. After the information is submitted (step 220), validation check including the process level, field level or the combination of both can be performed (step 230). The validated information is then processed to check if user 110 is allowed to access the selected banking service for the required financial product (step 240). After processing the verified information, a reference number corresponding to the selected banking service is provided to the user, thereby originating a banking relationship between user 110 and bank 120 (step 250).

Thus, user 110 can originate a banking relationship with bank 120 by various electronic communication channels. It may be appreciated that user 110 can also originate a banking relationship by visiting a branch of a bank. The user can fill in the form for accessing a financial product and the processing of the form may be completed as per the process described below.

In an embodiment, user 110 can use different electronics communication channel during the process of originating a banking relationship. For example, if a user has filled the information in the template using his computer system over internet, then the user can modify the information on the template using his mobile by calling the call center and submit the template. Use of different electronic communication system is not limited only during the process of originating a banking relationship; it can be extended to perform transactions after origination of the banking relationship. In one embodiment, alerts are sent to the user during the process of origination of banking relationship.

In yet another embodiment, a user may be provided with a login id which can be used to save the credentials of the user for accessing any financial product. This option may further help him to check the status of the banking service he has opted for. Additionally, the user may be provided with an option to make a contact with the bank in case of requirement of any clarification/question. This contact can be provided by way of chat facilities or over the phone. Further, the user may be provided with the facility of giving the feedback or rating the service provided by the bank.

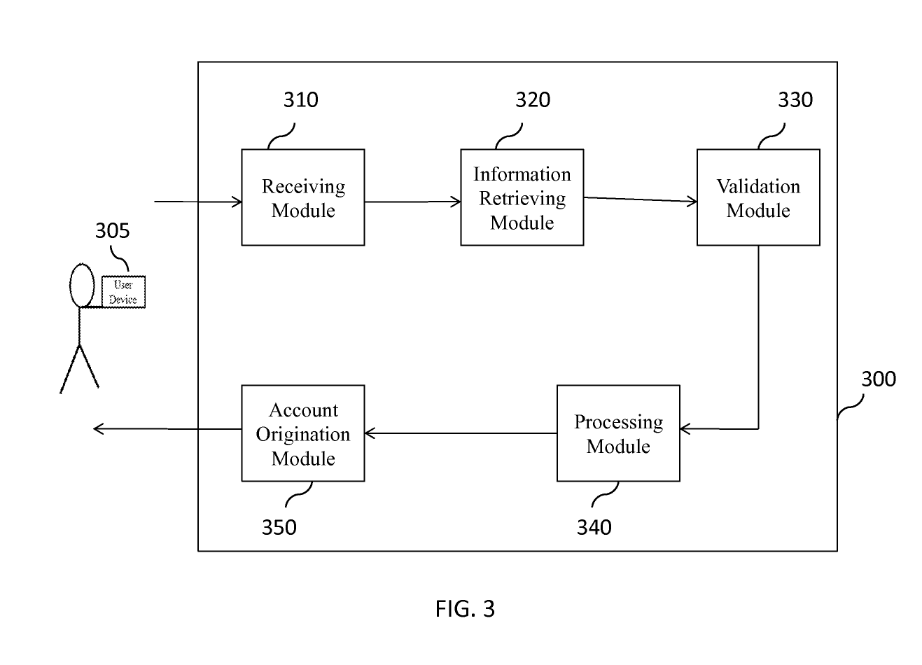

FIG. 3 is a block diagram illustrating the details of a system enabling a user to originate a banking relationship with a bank using different electronic communication channel in which several aspects of the present disclosure can be implemented. System 300 is shown containing receiving module 310, information retrieving module 320, validation module 330, processing module 340 and account origination module 350 is shown.

System 300 provides a user interface which displays template on a user device 305 for the user to select any of the listed banking services. User device may be any computing device, e.g., a desktop computer, smartphone, tablet, special purpose device, or other computing device that may be accessed by the user. Receiving module 310 receives a request for a banking service for a financial product from user 110. After processing the selected banking service, a template is configured based on the selected financial product like for the issuance of credit card, the template is configured to have requirements necessary for the issuance of the credit card. However, these requirements may change for other financial products. The configured template is displayed on the user interface for the user to fill in information as required in the template. In one embodiment, the template can be configured based on different parameters like geographical regulation of the bank or user, selection of financial product by the user, preference of the user etc. Information retrieving module 320 may receive the user requested banking service from receiving module 310 and provides user 110 a template to retrieve information once the user fills in his information in the template. Retrieved information can be transferred to validation module 330. Validation module 330 can perform process level or field level or combination of process and field level validation. Validation can be done at technical and business level. In one of the embodiment, custom validation can be performed on the retrieved information. The rules for the custom validation may be set by the Bank.

After validation, the information may be processed at processing module 340 which checks if the user is allowed to access the requested banking service. In one embodiment, processing module 340 may check if there is any duplication of the information.

The function of each module can be performed by a single module. In one embodiment, processing module evaluated the information provided by the user and accordingly inform the user about other options like cross-sell, up-sell, down-sell based on the evaluated information. Once the information is processed, account origination module 350 gives the access of the requested banking service to the user, thereby originating a banking relationship with the user. In one embodiment, the system is configured to provide the user with different tools like calculators, simulators, modelers to demonstrate a plurality of benefits and features of the banking relationship. In one embodiment, each of the modules can be configured to work in combination. For example function of receiving module and information retrieving module can be performed by a single module.

### Example Embodiments

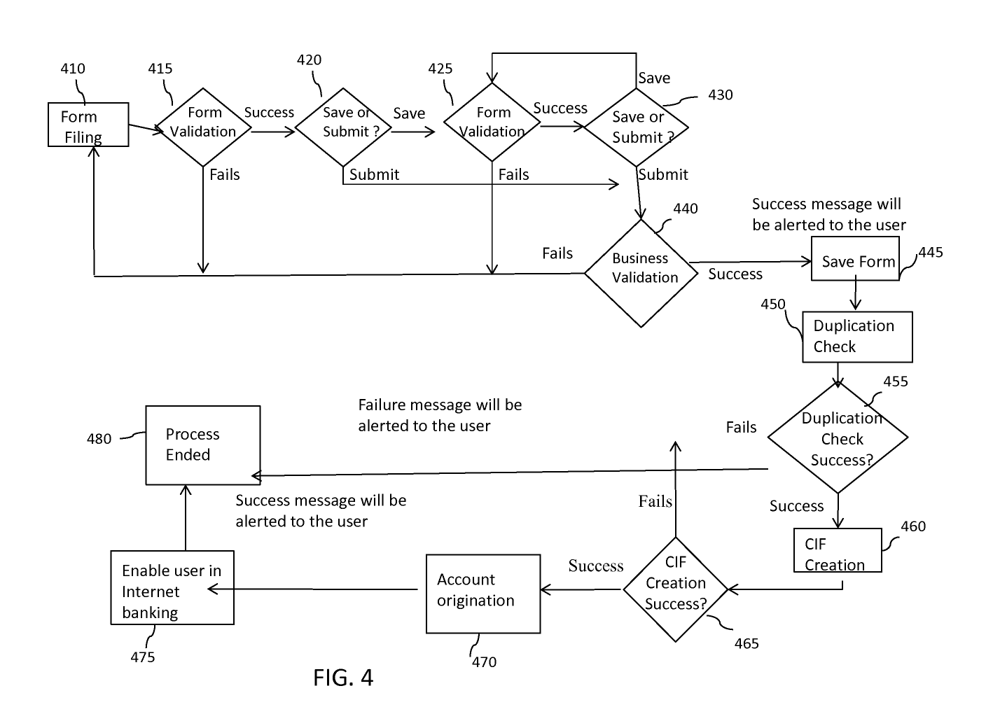

FIG. 4 is an example embodiment according to an aspect of the present invention. A process of originating a banking relationship using electronic communication channel with a bank is shown. A user selects for a banking service for a financial product and fills up information in a corresponding form using an electronic communication channel (step 410). Form can be saved before submitting it. Saved form can be accessed from any electronic communication channel and modified anytime before submitting it. The information is verified before saving it. In one embodiment, the information can be verified at one step or continuously during the process. If the validation fails, the user is informed to fill in the correct information again. When the user submits the form, business validation is performed. In business validation, user information is checked if he is allowed to access selected banking service as per the business policies. If the business validation fails, the user is informed of the failure in accessing the banking service.

After Business validation, the form is saved and processed. The processing of the form may include many steps. The steps involved in processing of the information on the form are configured by the bank. For example, the bank can configure the system to perform the duplication check before the creation of customer (herein refers to user) information file. Duplication check is performed on the information provided in the form. If a duplicate entry is found, the user is alerted of the failure to originate banking relationship due to duplication of information. If the duplication check is cleared, the information is sent for CIF (customer information file) creation. If CIF creation fails, failure message is sent to the user. If CIF creation is successful, an account corresponding to financial product is originated. User is enabled for internet banking to access and make transactions to/from the account. After the account is originated and internet banking username is created, user is provided the information of the account and the internet banking details with a success message that his request to originate a banking relation is complete.

### Exemplary Computing Environment

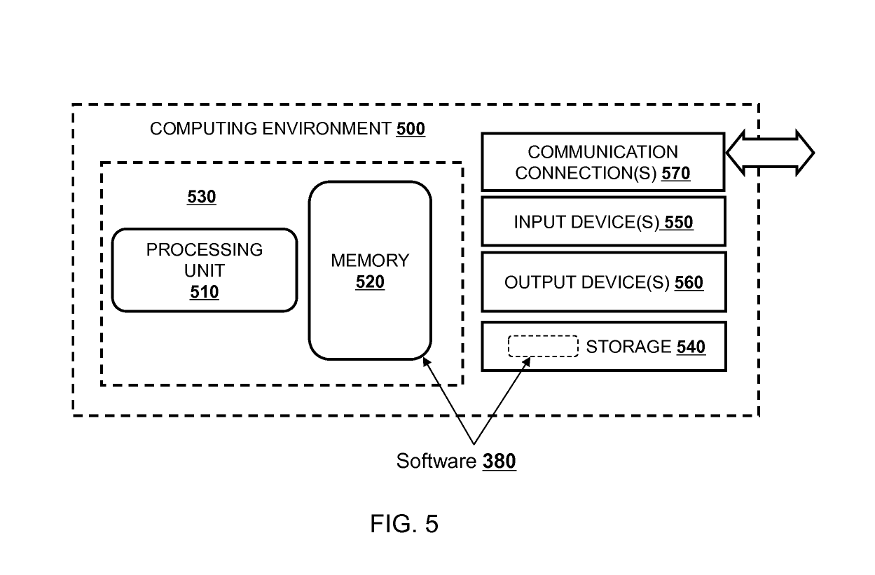

One or more of the above-described techniques may be implemented in or involve one or more computer systems. FIG. 5 illustrates a generalized example of a computing environment 500. The computing environment 500 is not intended to suggest any limitation as to scope of use or functionality of described embodiments.

With reference to FIG. 5, the computing environment 300 includes at least one processing unit 510 and memory 520. In FIG. 5, this most basic configuration 530 is included within a dashed line. The processing unit 510 executes computer-executable instructions and may be a real or a virtual processor. In a multi-processing system, multiple processing units execute computer-executable instructions to increase processing power. The memory 520 may be volatile memory (e.g., registers, cache, RAM), non-volatile memory (e.g., ROM, EEPROM, flash memory, etc.), or some combination of the two. In some embodiments, the memory 520 stores software 580 implementing described techniques.

A computing environment may have additional features. For example, the computing environment 500 includes storage 540, one or more input devices 550, one or more output devices 560, and one or more communication connections 570. An interconnection mechanism (not shown) such as a bus, controller, or network interconnects the components of the computing environment 500. Typically, operating system software (not shown) provides an operating environment for other software executing in the computing environment 500, and coordinates activities of the components of the computing environment 500.

The storage 540 may be removable or non-removable, and includes magnetic disks, magnetic tapes or cassettes, CD-ROMs, CD-RWs, DVDs, or any other medium which may be used to store information and which may be accessed within the computing environment 500. In some embodiments, the storage 540 stores instructions for the software 580.

The input device(s) 550 may be a touch input device such as a keyboard, mouse, pen, trackball, touch screen, or game controller, a voice input device, a scanning device, a digital camera, or another device that provides input to the computing environment 500. The output device(s) 560 may be a display, printer, speaker, or another device that provides output from the computing environment 500.

The communication connection(s) 570 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 500, computer-readable media include memory 520, storage 540, communication media, and combinations of any of the above.

Having described and illustrated the principles of our invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

1. A computer implemented method executed by one or more computing devices for originating a banking relationship using at least one electronic communication channel, the method comprising:
receiving a request from a user through a first electronic communication channel wherein the user selects a financial product among a list of different financial products offered by a bank;
enabling the user to send a user information through a second electronic communication channel;
receiving a user information through at least one of:
the first electronic communication channel; and
the second electronic communication channel;
performing at least one validation check on the user information;
processing the user information to check if the user is allowed to access the selected financial product; and
originating the banking relationship for the user.

2. The method of claim 1, further comprising providing the user with at least one banking relationship reference number.

3. The method of claim 1, further comprising saving the user information before processing.

4. The method of claim 1, further comprising enabling the user to perform one or more of: cross-sell, up-sell, down-sell based on the user information specifically evaluated for each user.

5. The method of claim 1, further comprising providing the user with different tools like calculators, simulators, modelers configured to demonstrate a plurality of benefits and features of the banking relationship.

6. The method of claim 1, further comprising sending the alerts to the user during the origination of the banking relationship.

7. The method of claim 1, wherein one of the at least one validation checks can be field level validation or process level validation or a combination thereof

8. The method of claim 1, wherein the processing of user information comprises checking duplicate entries of the user information.

9. The method of claim 1, wherein the user is enabled to select one or more financial product by submitting the user information at most once.

10. The method of claim 1, wherein the first electronic communication channel and the second electronic communication channel both comprises a wired communication channel or a wireless communication channel or a combination thereof

11. The method of claim 1, wherein the financial product comprises at least one of:
demat account, loan account, mortgage account, credit card account, insurance, savings bank account, current account, mutual fund account, recurring deposit account, fixed deposit account, proprietorship account, partnership account, joint account, overdraft account, transactional account, any other bank account type offered by the bank or a combination thereof.

12. The method of claim 1, further comprising: enabling the user to create a joint account, wherein a joint account user can independently submit the user information for the joint account.

13. The method of claim 1, wherein the user in enabled to select at least one financial product on a template.

14. The method of claim 1, wherein the user information is received on the template.

15. The method of claim 13, wherein the template is configured based on the selected financial product.

16. The method of claim 13, wherein the template is customized based on one or more of:
geographical regulations;
selection of the financial products; and
preference of the user.

17. The method of claim 1, further comprising enabling the bank to configure the processing of the user information

18. A system for originating the banking relationship using at least one electronic communication channel, comprising:
receiving module configured to receive a request from a user through a first electronic communication channel wherein the user selects a financial product among a list of different financial products offered by a bank;
information retrieving module configured to receive a user information through at least one of:
the first electronic communication channel; and
a second electronic communication channel;
validation module configured to perform at least one validation check on the user information;
processing module configured to check the eligibility criteria of the user to access the selected financial product; and
origination module configured to originate the banking relationship for the user.

19. The system of claim 18, wherein the first electronic communication channel and the second communication channel both comprises a wired communication channel or a wireless communication channel or a combination thereof.

20. The system of claim 18, wherein the financial product comprises at least one of: demat account, loan account, mortgage account, credit card account, insurance, savings bank account, current account, mutual fund account, recurring deposit account, fixed deposit account, proprietorship account, partnership account, joint account, overdraft account, transactional account, any other bank account type offered by the bank or a combination thereof.

21. The system of claim 18, wherein the origination module is further configured to provide the user with at least one banking relationship reference number.

22. The system of claim 18, wherein the processing module is further configured to enable the user to perform one or more of: cross-sell, up-sell, down-sell based on the user information specifically evaluated for each user.

23. The system of claim 18, wherein the processing module is further configured to send the alerts to the user during the origination of the banking relationship.

24. The system of claim 18, wherein one of the at least one validation checks can be field level validation or process level validation or a combination thereof

25. The system of claim 18, wherein the processing module is further configured to check duplicate entries of the user information.

26. The system of claim 18, wherein the processing module is further configured to enable the user to create a joint account, wherein a joint account user can independently submit the user information for the joint account.

27. The system of claim 18, wherein the receiving module is further configured to receive at least one selected financial product on a template.

28. The system of claim 27, wherein the information retrieving module is further configured to receive the user information on the template.

29. The system of claim 27, wherein the processing module is further configured to configure the template based on the selected financial product.

30. The system of claim 18, wherein the processing module is further configured to customize the template based on one or more of:
geographical regulations;
selection of the financial products; and
preference of the user.

31. The system of claim 18, wherein the processing module is further configured to enable the bank to configure processing of the user information.

32. A computer program product comprising a computer usable medium having a computer readable program code embodied therein for originating a banking relationship using at least one electronic communication channel, the product comprising:
program code adapted for receiving a request from a user through a first electronic communication channel wherein the user selects a financial product among a list of different financial products by a bank;
program code adapted for enabling the user to send a user information through a second electronic communication channel;
program code adapted for receiving a user information through at least one of:
the first electronic communication channel; and
the second electronic communication channel;
program code adapted for performing at least one validation check on the user information;
program code adapted for processing the user information to check if the user is allowed to access the selected financial product; and
program code adapted for originating the banking relationship for the user.

33. The product of claim 32, further comprising program code adapted for providing the user with at least one banking relationship reference number.

34. The product of claim 32, further comprising program code adapted for saving the user information before processing.

35. The product of claim 32, further comprising program code adapted for enabling the user to perform one or more of: cross-sell, up-sell, down-sell based on the user information specifically evaluated for each user.

36. The product of claim 32, further comprising program code adapted for providing the user with different tools like calculators, simulators, modelers configured to demonstrate a plurality of benefits and features of the banking relationship.

37. The product of claim 32, further comprising program code adapted for sending the alerts to the user during the origination of the banking relationship.

38. The product of claim 32, wherein the financial product comprises at least one of: demat account, loan account, mortgage account, credit card account, insurance, savings bank account, current account, mutual fund account, recurring deposit account, fixed deposit account, proprietorship account, partnership account, joint account, overdraft account, transactional account, any other bank account type offered by the bank or a combination thereof.

39. The product of claim 32, further comprising program code adapted for enabling the user to create a joint account, wherein a joint account user can independently submit the user information for the joint account.

40. The product of claim 32, further comprising program code adapted for enabling the bank to configure the processing of the user information.
